(19) United States
(12) Patent Application Publication
(10) Pub. No.: US 2020/0083738 A1
(43) Pub. Date: Mar. 12, 2020

(54) WIRELESS CHARGING SYSTEM AND WIRELESS CHARGING RECEIVING DEVICE

(71) Applicant: KNOWMAX TECHNOLOGY LTD., TAIPEI CITY (TW)

(72) Inventors: KUO-CHAN HUANG, TAIPEI CITY (TW); CHE-YING LI, TAIPEI CITY (TW)

(21) Appl. No.: 16/610,320

(22) PCT Filed: May 4, 2018
(86) PCT No.: PCT/CN2018/085595

§ 371 Date: Nov. 1, 2019

(30) Foreign Application Priority Data
May 5, 2017 (CN) 201710312061.5

(51) Int. Cl. H02J 7/02; H02J 50/10; H02J 50/80

(52) U.S. Cl. CPC H02J 7/025; H02J 7/027; H02J 50/80; H02J 50/10

(57) ABSTRACT

A wireless charging receiver includes an output unit, a protective unit in parallel with the output unit. The protective unit comprises a protective load and a protective switch in series with the protective load. Wherein the protective switch is activated to make the current flow through the protective load to reduce an output current and an output power of the output unit if the output voltage of the output unit is detected higher than a protection activating voltage.

### CROSS-REFERENCES TO RELATED APPLICATIONS

The present application claims priority to China Application No. 201710312061.5 filed May 5, 2017, which is incorporated herein by reference in its entirety.

### BACKGROUND OF THE INVENTION

### 1. Field Of The Invention

The present disclosure relates to a wireless charging device. More particularly, the disclosure relates to a receiving device for wireless charging.

### 2. Description Of Related Art

Most electronic devices being charged or the charging system may be damaged while the voltage exceeds the predetermined voltage. However, the ideal charging voltage often fluctuates with the maximum rated power and the output load of the wireless receiving device during wireless charging.

Further, the charging power of the wireless charging system are also affected by factors such as surplus energy transmitted from the transmitting device to the receiving device, movement of the receiver and the load, and a sudden decrease in the power of the electronic device during charging. Changes in charging power can also damage the charged electronic device or the charging system.

In view of the above, there exist in this art a need of an improved charging device that may protect the device from damage by sudden voltage surges during wireless charging.

### SUMMARY

Based on the property of the chip of the wireless charging receiver, the higher current, as long as under the temperature limit, will not cause unrecoverable damage during a short time while the higher voltage may cause permanent damage. Therefore, embodiments of the disclosure utilize the property to protect the wireless charging receiver with a protective load. After the protective load is used, even though the current flowing through the chip of the wireless charging receiver increases, the chip of the wireless charging receiver can be protected because the voltage is maintained under the limit that can be tolerated by the chip of the wireless charging receiver.

In addition, another embodiment of the present invention provides multiple sets of protective loads, which can be used based on the status of the load of the charging system to improve the security of the charging system.

Many of the attendant features and advantages of the present disclosure will becomes better understood with reference to the following detailed description considered in connection with the accompanying drawings.

### BRIEF DESCRIPTION OF THE DRAWINGS

The present description will be better understood from the following detailed description read in light of the accompanying drawings, where:

FIG. 1 is a schematic diagram depicting the components and interaction between a wireless charging transmitting device and a wireless charging receiving device in accordance with one embodiment of the present disclosure;

FIG. 2 is a flowchart depicting the steps for activating or deactivating the protective switch of the receiving device in accordance with one embodiment of the present disclosure;

FIG. 3 is a flowchart depicting the steps for activating or deactivating the protective switch and the output unit of the receiving device in accordance with one embodiment of the present disclosure;

FIG. 4 a schematic diagram depicting the components and interaction between a wireless charging transmitting device and a wireless charging receiving device having at least two protective units in accordance with one embodiment of the present disclosure;

FIG. 5 is a flowchart depicting the steps for activating or deactivating the protective switch and the output unit of the receiving device exemplified in FIG. 4; and

FIG. 6 is a flowchart depicting optional steps for activating or deactivating the protective switch and the output unit of the receiving device exemplified in FIG. 4.

In accordance with common practice, the various described features/elements are not drawn to scale but instead are drawn to best illustrate specific features/elements relevant to the present invention. Also, like reference numerals and designations in the various drawings are used to indicate like elements/parts.

### DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The singular forms “a,” “and,” and “the” are used herein to include plural referents unless the context clearly dictates otherwise.

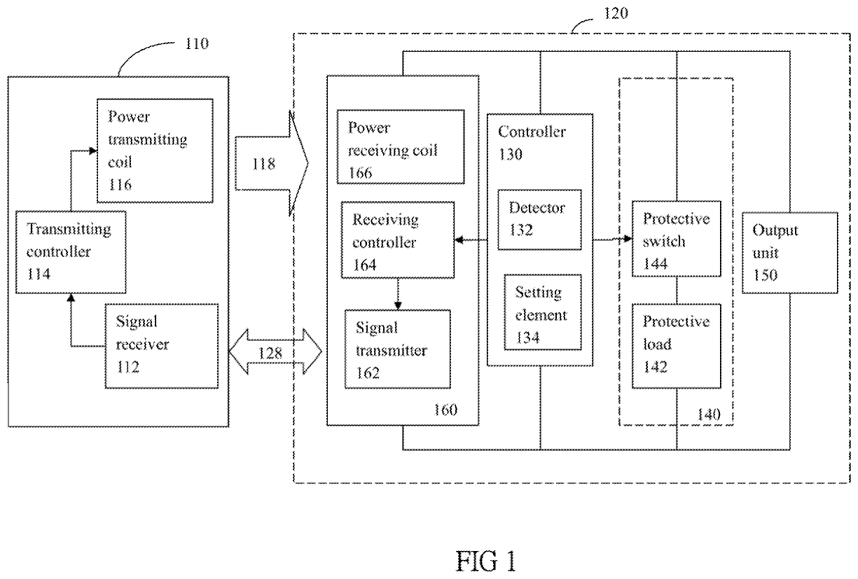

FIG. 1 is a schematic diagram depicting the components and interaction between a wireless charging transmitting device 110 and a wireless charging receiving device 120 in accordance with one embodiment of the present disclosure. As depicted, the receiving device 120 comprises an input unit 160, a controller 130, a protective unit 140, and an output unit 150. The input unit 160 includes a power receiving coil 166, a signal transmitter 162, and a receiving controller 164. The transmitting device 110 comprises a signal receiver 112, a transmitting controller 114, and a power transmitting coil 116. The transmitting power 118 is transmitted between the power transmitting coil 116 of the transmitting device 110 and the power receiving coil 166 of the receiving device 120, and the signal 128 is transmitted between the signal receiver 112 of the transmitting device 110 and the signal transmitter 162 of the receiving device 120.

When the wireless charging receiving device 120 is in use, the output unit 150 of the receiving device 120 is electronically connected to an electronic device (e.g., a cell phone) to supply electricity thereto. The protective unit 140 of the receiving device 120 is configured to be parallel connected to the output unit 150 to prevent the charged electronic device or the charging system from being damaged due to the increased output voltage of the output unit 150. The protective unit 140 of the receiving device 120 comprises a protective load 142, and a protective switch 144 configured to be serially connected to the protective load 142. When the protective switch 144 is activated, the current will flow through the protective load 142. The controller 130 of the receiving device 120 comprises a detector 132 for measuring an output voltage (Vo) across the output unit 150, and a setting element 134 for setting a high-load power (P_{H}) and a low-load power (P_{L}) of the output unit 150, and a protection activating voltage and a protection deactivating voltage of the protective switch 144.

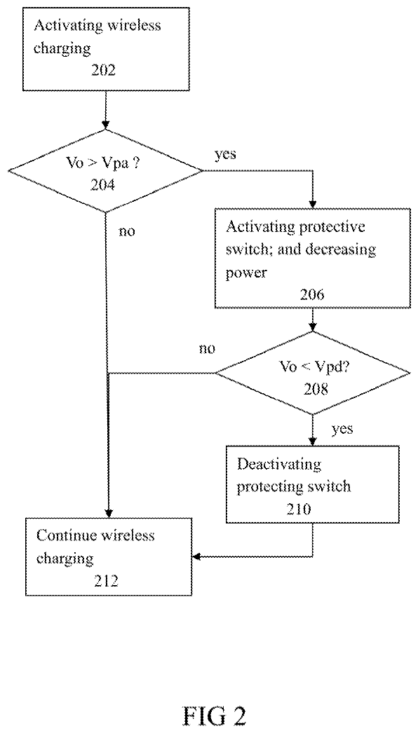

Reference is now made to FIG. 2, which is a flowchart depicting the steps for activating or deactivating the protective switch 144 of the receiving device 120. After the receiving device 120 is activated (step 202), the output voltage (V_{O}) of the output unit 150 is measured to be compared with a protection activating voltage (Vpa) for activating the protective switch 144 (step 204). If the output voltage (V_{O}) is not higher than the protection activating voltage (Vpa), the wireless charging will continue (step 212). Otherwise, if the output voltage (Vo) of the output unit 150 exceeds the protection activating voltage (Vpa), which may be predetermined by the setting element 134 of the controller 130, the controller 130 will activate the protective switch 144 to direct current to flow through the protective load 142 to decrease the output current and the output power of the output unit 150. Optionally, the controller 130 can request the output unit 150 to decrease its voltage output (step 206). The detector 132 continues to monitor the voltage across the output unit 150 to see if the output voltage (Vo) of the output unit 150 has decreased to be lower than a protection deactivating voltage (Vpd), which may also be predetermined by the setting element 134 of the controller 130 (step 208). If the output voltage (V_{O}) is lower than the protection deactivating voltage (Vpd), the protective switch 144 is deactivated (step 210) and all of the current will flow through the output unit 150 to increase the output current or output power of the output unit 150. .

Returning to FIG. 1, the setting element 134 of the controller 130 may include a resistor, a switch, and/or a software (not shown) for setting both the protection activating voltage (Vpa) and the protection deactivating voltage (Vpd). Alternatively, the protection activating voltage (Vpa) and the protection deactivating voltage (Vpd) may vary with the high-load power (P_{H}) and the low-load power (P_{L}) predetermined by the controller 130.

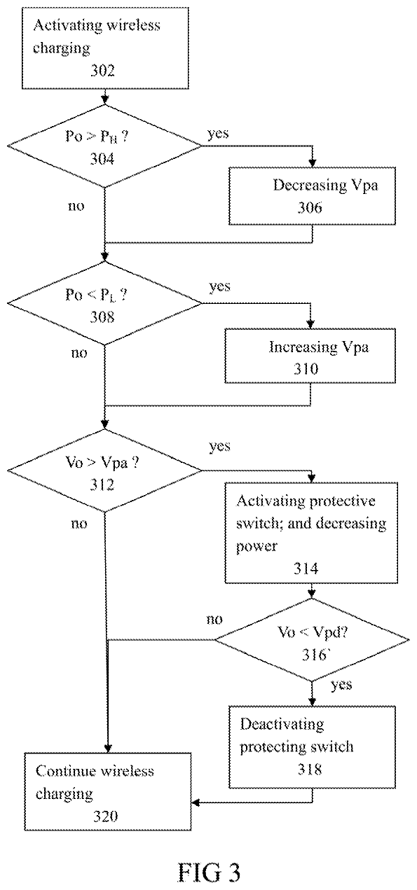

Reference is now made to FIG. 3, which is a flowchart depicting the steps for activating or deactivating the protective switch 144 and the output unit 150 of the receiving device 120. After the receiving device 120 is activated (step 302), when the detector 132 detects that the output power (Po) of the output unit 150 is higher than a high-load power (P_{H}) (step 304), the controller 130 will proceed to decrease the protection activating voltage (Vpa) to make the output voltage (Vo) of the output unit 150 higher than the protection activating voltage (Vpa) to activate the protective switch 144 in step 314 and prevent the charged electronic device from be damaged. Further, if the condition that the output power (Po) of the output unit 150 is lower than a low-load power (P_{L}) is determined (step 308), the controller 130 will proceed to increase the protection activating voltage (Vpa) (step 310) to make the output voltage (Vo) of the output unit 150 lower than the protection activating voltage (Vpa) to prevent the protective switch 144 from being activated in step 314, and thus to continue the wireless charging (step 320).

Returning to FIG. 1, when the output power (Po) from the output unit 150 is higher than the protection activating voltage (Vpa) and the protective switch 144 is activated, the controller 130 may also send a signal 128 to the wireless charging transmitting device 110 via a signal transmitter 162 of an input unit 160 to request the transmitting device 110 to decrease its transmitting power. Once the signal 128 is received by a signal receiver 112 of the transmitting device 110, a transmitting controller 114 of the transmitting device 110 will control a power transmitting coil 116 to decrease the transmitting power.

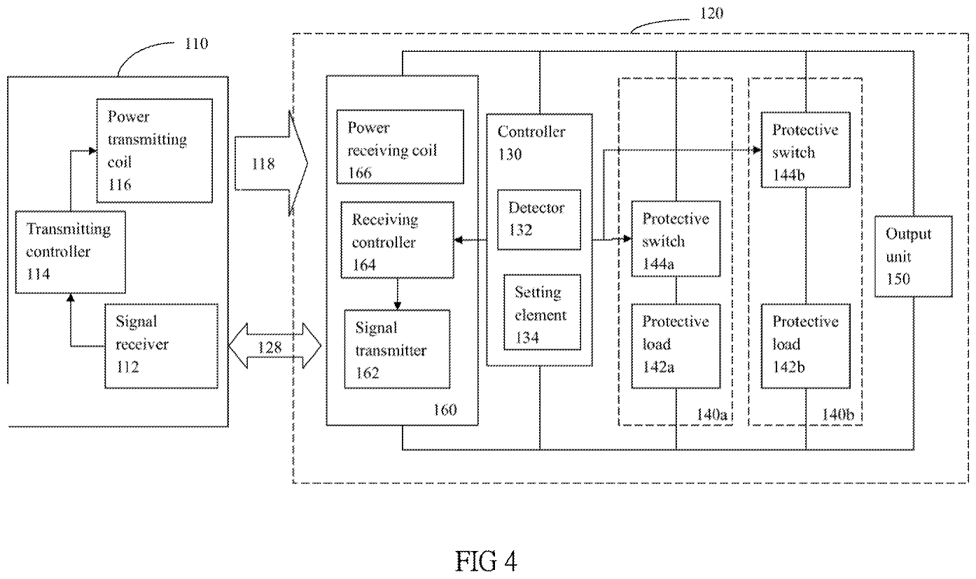

FIG. 4 is a schematic diagram depicting another embodiment of the present disclosure, the components and arrangement of the transmitting device 110 and the receiving device 120 are similar to those in FIG. 1, except that the receiving device 120 comprises at least two protective units 140a, 140b. In this configuration, the protective units 140a, 140b are in parallel, and are in parallel connection to the output unit 150. Similar to that in FIG. 1, the protective unit 140a comprises a protective load 142a and a protective switch 144a serially connected to the protective load 142a. The current cannot flow through the protective load 142a when the protective switch 144a is deactivated.

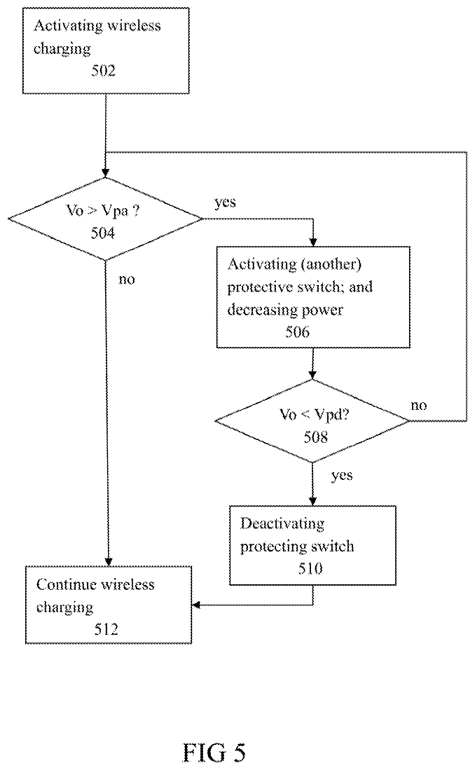

Reference is now made to FIG. 5, which is a flowchart depicting the steps for activating or deactivating one or more protective switch of the receiving device. After the receiving device 120 is activated (step 502), the condition that if the output power (Po) of the output unit 150 is higher than the protection activating voltage (Vpa) is determined (step 504). If the output voltage (V_{O}) is lower than the protection activating voltage (Vpa), the wireless charging will continue (step 512). Otherwise, if the output power (Po) of the output unit 150 is higher than the protection activating voltage (Vpa), the controller 130 will activate one or more of the protective switches to direct current to flow through one or more of the protective load 142a, 142b to decrease the output current and the output power of the output unit 150. Optionally, the controller 130 can also request the output unit 150 to decrease its voltage output (step 506). When multiple protective switches are activated, such as protective switches 144a, 144b, they may be activated sequentially or simultaneously. The detector 132 continues to monitor the output voltage (Vo) across the output unit 150 to determine if the output voltage (Vo) of the output unit 150 is higher than a protection deactivating voltage (Vpd) (step 508). If the output voltage (Vo) of the output unit 150 is higher than a protection deactivating voltage (Vpd), the flow returns to step 504. Otherwise, if the output voltage (V_{O}) is lower than the protection deactivating voltage (Vpd), one or more of protective switches are deactivated (step 510) to make more current flow through the output unit 150 and increase the output current or output power of the output unit 150. When multiple protective switches are to be deactivated, they may be deactivated sequentially or simultaneously.

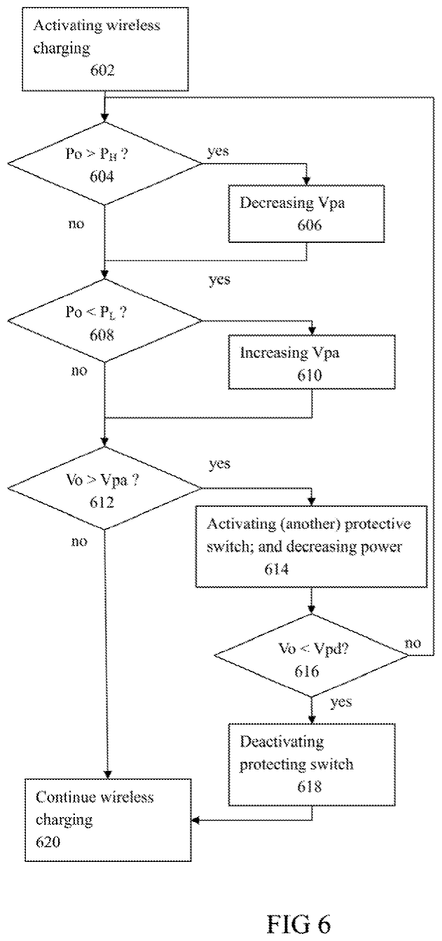

Reference is now made to FIG. 6, which is a flowchart depicting the steps for activating or deactivating the protective switches and the output unit 150 of the receiving device 120. Similar to steps depicting in FIG. 3, both the protection activating voltage (Vpa) and protection deactivating voltage (Vpd) may vary with high-load power (P_{H}) and the low-load power (P_{L}), which can be set in the setting element 134. After the receiving device 120 is activated (step 602), the condition that if the output power (Po) of the output unit 150 is higher than a high-load power (P_{H}) is determined (step 604), the controller 130 will proceed to decrease the protection activating voltage (Vpa) (step 606) to make the output voltage (Vo) of the output unit 150 higher than the protection activating voltage (Vpa) (step 612) and thus one or more of the protective switches can be activated in step 614 to prevent the charged electronic device from being damaged. Further, when the condition that the output power (Po) of the output unit 150 is lower than a low-load power (P_{L}) is determined (step 608), the controller 130 will proceed to increase the protection activating voltage (Vpa) (step 610) to make the output voltage (Vo) of the output unit 150 lower than the protection activating voltage (Vpa) to prevent the protective switch from being activated in step 614.

Further, in the process depicted in FIG. 6, the detector 132 will continue monitoring the output voltage (Vo) across the output unit 150 to determine if the output power (Po) of the output unit 150 is lower than the protection deactivating voltage (Vpd) (step 616). If the output voltage (V_{O}) is lower than the protection deactivating voltage (Vpd), one or more of protective switches are deactivated (step 618). Otherwise, if the output voltage (V_{O}) is higher than the protection deactivating voltage (Vpd), the process will return to step 604, and the controller 130 can decrease the protection activating voltage (Vpa) in step 606 or increase the protection activating voltage (Vpa) in step 610 by adjusting the high-load power (P_{H}) and the low-load power (P_{L}) based on the determination made in steps 604 and 608. In step 612, the condition that if the output voltage (V_{O}) is higher than the protection activating voltage (Vpa) is determined. If the output voltage (V_{O}) is lower than the protection activating voltage (Vpa), the wireless charging may continue (step 620). Otherwise, if the output voltage (Vₒ) is higher than the protection activating voltage (Vpa), the process will proceed to activate the remaining un-activated protective switches (step 614), and then determine if the output voltage (Vo) of the output unit 150 is lower than the protection deactivating voltage (Vpd) (step 616). If the output voltage (Vo) of the output unit 150 is lower than the protection deactivating voltage (Vpd), one or more of protective switches can be deactivated (step 618). Otherwise, the processes will return to step 604 and repeat the loop until the output voltage (Vo) of the output unit 150 is lower than the protection deactivating voltage (Vpd).

It will be understood that the above description of embodiments is given by way of example only and that various modifications may be made by those with ordinary skill in the art. The above specification, examples, and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A wireless charging receiving device comprising, an output unit;
a protective unit parallel connected to the output unit comprising:
a protective load, and
a protective switch serially connected to the protective load to control a current flowing through the protective load; and
a controller comprising a detector for measuring an output voltage of the output unit,
wherein the controller activates the protective switch to make the current flow through the protective load when the output voltage is higher than a protection activating voltage.

2. The wireless charging receiving device of claim 1, wherein when the output voltage is lower than a protection deactivating voltage, the controller deactivates the protective switch to increase the current flowing through the output unit to increase an output power and an output current of the output unit.

3. The wireless charging receiving device of claim 1, wherein the controller increases the protection activating voltage when the detector detects that an output power of the output unit is lower than a low-load power.

4. The wireless charging receiving device of claim 1, wherein the controller decreases the protection deactivating voltage when the detector detects that an output power of the output unit is higher than a high-load power.

5. The wireless charging receiving device of claim 1, wherein the controller further comprises a setting element for setting a low-load power, a high-load power, the protection activating voltage, and a protection deactivating voltage.

6. The wireless charging receiving device of claim 1, wherein the controller transmits a signal to a wireless charging transmitting device to request the wireless charging transmitting device to decrease a transmitting power when the output voltage of the output unit is higher than the protection activating voltage.

7. The wireless charging receiving device of claim 1, wherein the controller further comprises a resistor or a switch for setting a low-load power, a high-load power, the protection activating voltage, and a protection deactivating voltage.

8. A wireless charging receiving device comprising, an output unit;
protective units, which are parallel connected and are parallel connected to the output unit, wherein each of the protective units includes:
a protective load, and
a protective switch serially connected to the protective load to control a current flowing through the protective load; and
a controller comprising a detector for measuring an output voltage of the output unit,
wherein the controller activates the protective switch of one of the protective units to make the current flow through the protective load of the one of the protective units when the output voltage is higher than a protection activating voltage, and
the controller activates the protective units one by one until the output voltage is lower than the protection activating voltage.

9. The wireless charging receiving device of claim 8, wherein when the output voltage is lower than a protection deactivating voltage, the controller deactivates the protective switch to increase the current flowing through the output unit to increase an output power and an output current of the output unit.

10. The wireless charging receiving device of claim 8, wherein the controller increases the protection activating voltage when the detector detects that an output power of the output unit is lower than a low-load power.

11. The wireless charging receiving device of claim 8, wherein the controller decreases the protection deactivating voltage when the detector detects that an output power of the output unit is higher than a high-load power.

12. The wireless charging receiving device of claim 8, wherein the controller further comprises a setting element for setting a low-load power, a high-load power, the protection activating voltage, and a protection deactivating voltage.

13. The wireless charging receiving device of claim 8, wherein the controller transmits a signal to a wireless charging transmitting device to request the wireless charging transmitting device to decrease a transmitting power when the output voltage of the output unit is higher than the protection activating voltage.

14. The wireless charging receiving device of claim 8, wherein the controller further comprises a resistor or a switch for setting a low-load power, a high-load power, the protection activating voltage, and a protection deactivating voltage.

15. A wireless charging system comprising:
a wireless charging receiving device comprising
a power receiving coil;
a signal transmitter;
an output unit;
a protective unit parallel connected to the output unit comprising:
a protective load, and
a protective switch serially connected to the protective load to control a current flowing through the protective load; and
a controller comprising a detector for measuring an output voltage of the output unit,
wherein the controller activates the protective switch to make the current flow through the protective load when the output voltage is higher than a protection activating voltage.
a wireless charging transmitting device comprising a signal receiver, a transmitting controller, and a power transmitting coil, wherein a transmitting power is transmitted between the power transmitting coil and the power receiving coil, and a signal is transmitted between the signal receiver and the signal transmitter.

16. The wireless charging system of claim 15, wherein the controller transmits the signal to the wireless charging transmitting device to request the wireless charging transmitting device to decrease the transmitting power when the output voltage of the output unit is higher than the protection activating voltage.

17. The wireless charging system of claim 15, wherein when the output voltage is lower than a protection deactivating voltage, the controller deactivates the protective switch to increase the current flowing through the output unit to increase an output power and an output current of the output unit.

18. The wireless charging system of claim 15, wherein the controller increases the protection activating voltage when the detector detects that an output power of the output unit is lower than a low-load power.

19. The wireless charging system of claim 15, wherein the controller decreases the protection deactivating voltage when the detector detects that an output power of the output unit is higher than a high-load power.

20. The wireless charging system of claim 15, wherein the controller further comprises a setting element for setting a low-load power, a high-load power, the protection activating voltage, and a protection deactivating voltage.
